(19) United States
(12) Patent Application Publication
(10) Pub. No.: US 2026/0346460 A1
(43) Pub. Date: Nov. 5, 2026

(54) Perioperative Cobotic System with Multimodal Imaging

(71) Applicant: Peritas AI Inc., Fort Lauderdale, FL (US)

(72) Inventor: Martin Roche, Fort Lauderdale, FL (US)

(73) Assignee: Peritas AI Inc., Fort Lauderdale, FL (US)

(21) Appl. No.: 19/431,987

(22) Filed: Dec. 23, 2025

Related U.S. Application Data
(63) Continuation-in-part of application No. 19/195,731, filed on Apr. 30, 2025.

(51) Int. Cl. B25J 9/16; B25J 5/00; B25J 19/02

(52) U.S. Cl. CPC B25J 9/1697; B25J 5/007; B25J 9/161; B25J 9/162; B25J 19/023

(57) ABSTRACT

A perioperative cobotic imaging system is disclosed that integrates robotic positioning with multimodal intraoperative imaging. The system includes a mobile collaborative robotic platform with an articulated arm supporting an imaging assembly comprising a fluoroscopic imaging device and an ultrasound imaging device. A control system coordinates robotic motion and synchronizes acquisition of imaging data across modalities. An image processing and fusion engine registers and combines fluoroscopic and ultrasound images to generate composite visualizations, optionally enhanced using artificial intelligence-based segmentation and anatomical labeling. Fused and individual imaging outputs are provided in real time through an interactive display interface that supports hands-free control via voice commands and sterile gesture recognition. The system further incorporates radiation safety controls, dynamic positioning compensation, and data integration with hospital information systems. The disclosed system enables precise, workflow-compliant, and safety-aware intraoperative imaging without manual manipulation of imaging devices.

### CROSS-REFERENCE TO RELATED APPLICATIONS

This patent application is a continuation-in-part of US Patent Application Ser. No. 19/195,731 filed on Apr. 30, 2025, which claims the benefit of priority to U.S. Provisional Patent Application No. 63/640,524, filed on Apr. 30, 2024, the entirety of which is incorporated herein by refer

### TECHNICAL FIELD

The present invention relates generally to surgical robotics and medical imaging systems, and more particularly to collaborative robotic platforms configured to acquire, process, and display multimodal intraoperative imaging data.

### BACKGROUND

Modern surgical environments increasingly rely on intraoperative imaging to enhance procedural precision, improve clinical outcomes, and enable real-time anatomical visualization. Imaging technologies such as fluoroscopy and ultrasound have become standard tools for orthopedic, cardiovascular, and minimally invasive surgeries. However, the deployment of these modalities remains fragmented, requiring manual positioning of imaging devices, separate control interfaces, and physical interaction by surgical personnel—frequently interrupting sterile workflow and introducing delays or misalignment during critical phases of a procedure.

Conventional imaging systems are typically mounted on large, fixed or mobile carts that lack integration with robotic positioning or intelligent control. Adjustments to imaging angle, resolution, or modality often require dedicated technicians, which can slow surgical progression and limit the responsiveness of imaging adjustments to changes in patient position or surgical context. Moreover, current systems generally do not support fusion of imaging data across modalities (e.g., combining fluoroscopic and ultrasound data), nor do they leverage artificial intelligence (AI) to assist with segmentation, anatomical labeling, or real-time visualization enhancement.

As surgical demands increase in complexity and operating room environments become more dynamic, there is a critical need for an integrated, intelligent imaging system capable of providing high-quality, real-time, multimodal imaging with minimal disruption to the sterile field. Robotic systems, particularly mobile cobots, offer the potential to automate the positioning and alignment of imaging devices with submillimeter precision, and to support intelligent control and image fusion that enhances intraoperative decision-making.

However, existing solutions lack key capabilities: they do not provide coordinated control over multiple imaging modalities, cannot dynamically compensate for patient movement or table adjustment, and often lack integrated safety protocols for radiation exposure, collision avoidance, or sterile field protection. Furthermore, few systems support hands-free interaction via voice or gesture commands, limiting their utility in maintaining sterile workflows.

Accordingly, there exists a need for a perioperative cobotic system equipped with multimodal imaging capabilities, including integrated fluoroscopy, ultrasound, and other modalities, that supports robotic articulation, AI-driven image fusion, real-time segmentation, and surgeon-accessible display interfaces, thereby enabling precise, responsive, and workflow-compliant intraoperative imaging in surgical settings.

### SUMMARY

The present disclosure provides a perioperative cobotic imaging system configured to acquire, process, and display multimodal intraoperative imaging data through a mobile robotic platform. The system includes a mobile base, an articulated robotic arm, and an integrated imaging assembly comprising a fluoroscopic imaging device, an ultrasound imaging device, and optionally other modalities such as optical, infrared, or hyperspectral sensors. The robotic platform is configured to autonomously navigate perioperative environments and to precisely position the imaging assembly relative to a surgical site.

A control system operatively coupled to the imaging assembly synchronizes and coordinates image acquisition across multiple modalities. Real-time imaging data is aligned using a registration module, fused by an image processing engine, and enhanced through application of artificial intelligence algorithms for segmentation and anatomical labeling. The fused composite images are displayed in real time on an interactive visualization interface, allowing surgical personnel to view, annotate, and toggle between imaging modes. Hands-free operation is enabled through voice and gesture command inputs, preserving sterile field integrity.

The system further includes robotic stabilization mechanisms, radiation safety features such as shielding and dose monitoring, and a data integration module configured to archive raw and processed imaging data and synchronize it with hospital information systems, including electronic medical records (EMRs) and PACS. Dynamic compensation for patient movement, surgical table tilt, or procedural changes is achieved through coordinated control of the robotic arm and imaging subsystems.

In various embodiments, the system supports intraoperative comparison to prior images, augmented or three-dimensional visualizations, and autonomous safety mechanisms for sterile field compliance and motion restraint.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIG. 1 is a perspective view of an exemplary perioperative cobotic imaging system.

FIG. 2 is a schematic block diagram of the system architecture.

FIG. 3 is a flowchart for coordinating positioning of the fluoroscopic and ultrasound devices.

FIG. 4 is a flowchart illustrating the process of multimodal image fusion.

FIG. 5 is a schematic representation of the fused composite image with anatomical overlays and user-selectable display options, as presented on a touchscreen or augmented reality interface.

FIG. 6 is a block diagram of the image fusion engine, showing input from multiple imaging modalities, real-time processing algorithms, segmentation output, and display integration.

FIG. 7 is a system diagram showing radiation safety protocols, including dose monitoring, dynamic exposure adjustment, and shielding controls during fluoroscopic imaging.

FIG. 8 is a diagram illustrating hands-free control through voice commands and sterile gesture recognition, enabling imaging adjustments without physical contact.

These drawings are provided for illustrative purposes only and should not be construed as limiting the invention to the specific embodiments shown and described herein. Variations and modifications to these embodiments will be apparent to those skilled in the art, and all such variations and modifications are intended to be included within the scope of this disclosure.

### DETAILED DESCRIPTION

Embodiments of the present disclosure are described below with reference to the accompanying drawings, which illustrate an exemplary perioperative cobotic system with multimodal imaging. These examples are presented in sufficient detail to enable those skilled in the art to practice the invention, but are not intended to limit the scope of the disclosure. Various modifications and alternative embodiments will be apparent to those skilled in the art. In the drawings, like reference numerals refer to like components throughout the figures. For clarity, certain elements may be shown in a simplified form or omitted to highlight pertinent aspects of the system.

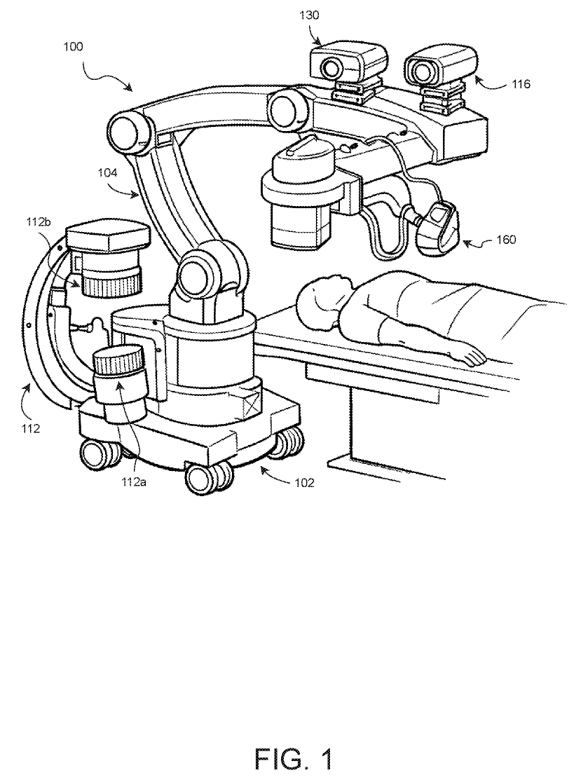

Referring now to FIG. 1, a perspective view of an exemplary perioperative cobotic imaging system 100 is shown. Cobotic system 100 is a mobile, collaborative robotic platform (cobot) designed for use in surgical environments, illustrating one embodiment of the present invention. The system 100 includes a mobile base 102, an articulated robotic arm 104, and an imaging assembly carried by the arm. The imaging assembly houses multiple imaging devices to provide multimodal imaging capabilities. In the embodiment of FIG. 1, these devices include a mini C-arm fluoroscopic X-ray unit 112 and an ultrasound imaging device 114 as primary modalities. The system 100 additionally supports other imaging sensors, such as a high-resolution optical camera 116 for visible-spectrum video and optional modules like a thermal or near-infrared sensor 118, although these are omitted in FIG. 1 for simplicity. The various components are arranged so that the cobot can be positioned adjacent to an operative site and deliver real-time fluoroscopic and ultrasonic images of a patient during surgery.

The mobile base 102 is a wheeled or powered cart-like structure that provides mobility and stability for the system 100. Base 102 may include omnidirectional wheels or casters driven by electric motors, allowing the system to autonomously navigate within perioperative environments (e.g., pre-op, intra-op, and post-op areas). The base 102 houses the primary power source (such as rechargeable batteries) and computing hardware, making the unit self-contained and untethered during operation. It incorporates obstacle detection sensors and sterile-field avoidance logic so that it can move freely without colliding with personnel or breaching sterile zones. In some embodiments, base 102 includes docking or stabilizing mechanisms (for example, floor locks or attachment points) that engage during imaging, this helps secure and stabilize the platform when the C-arm 112 is taking images, reducing vibration or drift. The platform is designed with smooth, easy-to-clean surfaces and compliance with hospital hygiene protocols. Safety features such as rounded edges and limited-force actuators allow the cobot to operate in close proximity to surgical staff.

Extending from the base is the articulated arm 104, which is a multi-jointed robotic manipulation arm configured to precisely position the imaging assembly 110. The arm 104 provides multiple degrees of freedom, enabling the system to move the fluoroscopic source and detector and the ultrasound probe 114 around the patient as needed. In FIG. 1, the arm 104 is shown in one possible position, but it can be reoriented and extended to various angles to reach over an operating table or around other equipment. This robotic articulation and positioning system is capable of fine adjustments and can hold the imaging devices steady during image capture. It may comprise segments with rotational joints, permitting the mini C-arm 112 to rotate about a region of interest and the ultrasound device 114 to be placed against the patient’s body at the appropriate location. The arm 104 is under computer control (via the system’s control unit, described later) and may automatically compensate for any patient movement or table repositioning. For example, if the patient shifts or if the operating table is tilted, the arm’s control system can dynamically adjust the arm’s pose to maintain the fluoroscope 112 and ultrasound probe 114 in optimal alignment with the surgical target. This dynamic compensation ensures stable imaging angles and focus throughout various surgical phases.

The imaging assembly at the distal end of arm 104 carries the core imaging modalities. As shown in FIG. 1, a mini C-arm fluoroscopic device 112 is mounted such that it can arc around the patient’s anatomy. The C-arm 112 includes an X-ray source 112a on one side and an X-ray detector 112b on the opposite side (the source/detector pair is schematically illustrated in later figures). This allows for real-time fluoroscopic imaging of internal structures (e.g., bones or implants) during surgery. The mini C-arm 112 is capable of rotational positioning around the surgical site to capture images at different angles, and it operates in a low-dose X-ray mode to minimize radiation exposure. Adjacent to the C-arm 112, the imaging assembly also supports an ultrasound imaging device 114. The ultrasound device 114 may be a robotic ultrasound probe or transducer that the arm can press against the patient’s skin near the surgical site to capture live ultrasound images of soft tissue structures (e.g., organs, vessels). The system is designed such that fluoroscopy and ultrasound can be used concurrently or in rapid sequence, providing complementary views of the operative field. Additional modalities: Optionally, as noted above, the system can incorporate other sensors like an optical camera 116 for standard video or surgical site documentation, as well as specialized imaging modules (thermal, NIR, depth sensors, etc.) for expanded multimodal functionality. These additional modalities, if present, are mounted on the arm 104 or base 102 in a manner that does not obstruct the primary fluoroscope and ultrasound functions. In typical use, the fluoroscopic X-ray and ultrasound serve as the primary imaging sources, while the other modalities can be activated as needed for supplementary information such as the registration and capture of anatomic structures. All imaging components are calibrated and aligned relative to each other so that their fields of view can be correlated.

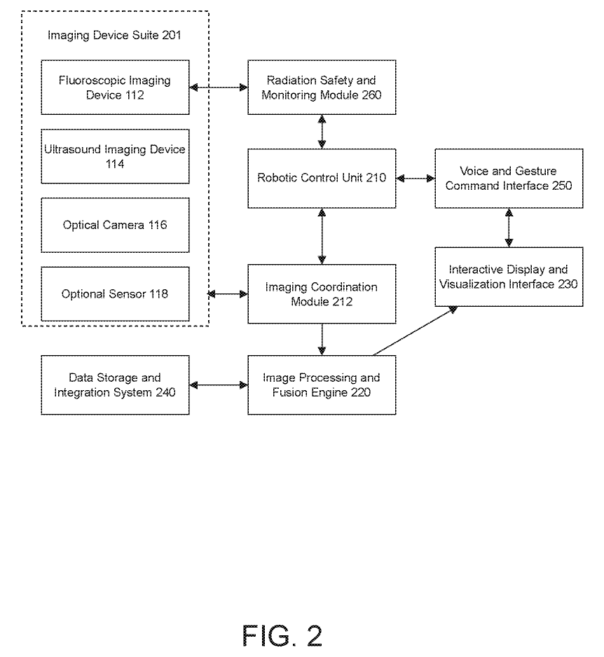

Turning to FIG. 2, a high-level system architecture block diagram of the perioperative cobotic imaging system is presented. FIG. 2 illustrates the major functional components and their interconnections. At the core of the system is a control and coordination subsystem, which includes a robotic control unit 210 and an imaging coordination module 212. The robotic control unit 210 comprises one or more processors and associated memory that govern the motion of the mobile base 102 and articulated arm 104 (e.g., controlling motors, receiving feedback from encoders and sensors). The imaging coordination module 212 works in conjunction with the control unit 210 to synchronize image acquisition across the different modalities. The various imaging devices (fluoroscopic C-arm 112, ultrasound device 114, and any additional sensors 116/118) are represented collectively in FIG. 2 as an imaging device suite 201, connected to the coordination module 212. The coordination module 212 triggers each device to capture images at the appropriate times and ensures that, for example, a fluoroscopic X-ray shot and an ultrasound frame correspond to the same anatomical moment or pose. It also handles calibration data so that images from different modalities are geometrically aligned (e.g. it may adjust the ultrasound probe orientation or C-arm angle to image the same region).

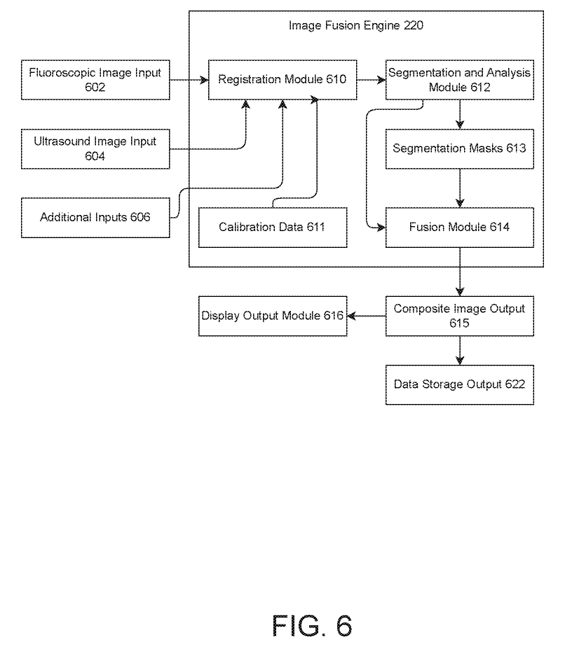

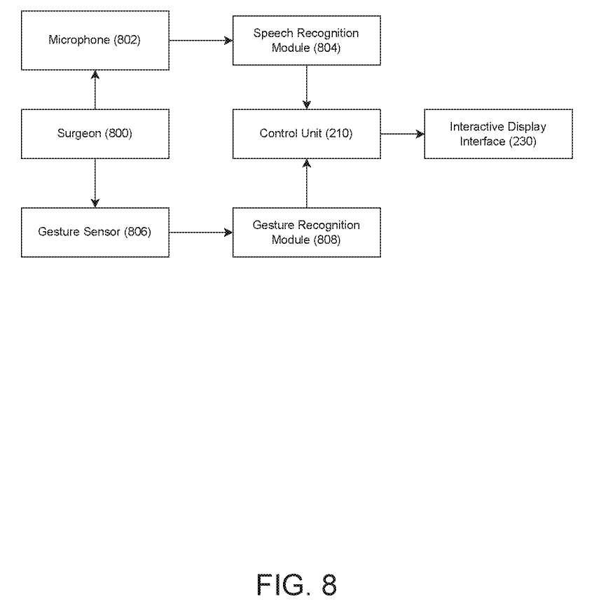

The imaging data from device suite 201 is fed into an image processing and fusion engine 220, which is a software (and possibly hardware-accelerated) component responsible for processing the incoming images and generating combined outputs. The image fusion engine 220 automatically registers the multi-modal image data and produces composite visualizations. This engine will be described in further detail with FIG. 6, but in brief it performs tasks such as image enhancement, AI-driven segmentation of anatomical features, and layering of images from different modalities to create a fused view. The output of the fusion engine is then provided to an interactive display and visualization interface 230. The interface 230 can include a physical display screen (for instance, a touchscreen monitor in the operating room) and/or wearable displays (such as a heads-up display or AR headset) through which the surgeon can view the live images. In addition to displaying the fused or individual modality images in real-time, interface 230 provides interactive controls for the user (surgeon or staff) to adjust the view. For example, the system allows the user to toggle between imaging modes, switch overlay on/off, change transparency of an ultrasound overlay on an X-ray image, zoom in on particular areas, or annotate the images with notes or measurements. User interaction with the interface can occur via touch input, voice commands, or gesture commands, as will be described with FIG. 8.

Also shown in FIG. 2 is a data storage and integration system 240. This subsystem represents the data management aspect of the cobotic system. It includes local storage for raw and processed imaging data, which can be tagged with patient identifiers, procedure type, and timestamps (e.g., indexing images by surgical phase or time). The storage 240 interfaces with hospital networks to synchronize data with external systems: for instance, it can send images or video to the patient’s electronic medical record (EMR) or to the Picture Archiving and Communication System (PACS) used for radiology. It can also retrieve prior imaging data (such as pre-operative CT or MRI scans, or previous fluoroscopy) for comparison or for use in registration. This integration allows the surgical team to reference earlier scans during the procedure and even have the fusion engine 220 overlay the current images with pre-op images for guidance. Security and compliance (HIPAA, etc.) are maintained in this data handling. Additionally, FIG. 2 includes a radiation safety and monitoring module 260, connected specifically to the fluoroscopic imaging device 112. Module 260 monitors X-ray emission parameters and includes safety interlocks to prevent unauthorized or unsafe operation of the X-ray source. The radiation safety module works closely with the control unit 210 to adjust exposure settings on the fly and to log the cumulative dose during the procedure. Finally, a voice and gesture command interface 250 is depicted, linking to both the control unit 210 and the display interface 230. This module comprises the hardware (microphones, cameras or motion sensors) and software needed to interpret spoken commands or hand gestures from the surgical staff, enabling sterile and hands-free control of the system. We will discuss the details of the voice/gesture interface with FIG. 8. In summary, FIG. 2 shows that the system architecture integrates the robotic motion control, multiple imaging inputs, a fusion processing engine, user interface/display, data management, safety controls, and advanced input interfaces into one cohesive platform.

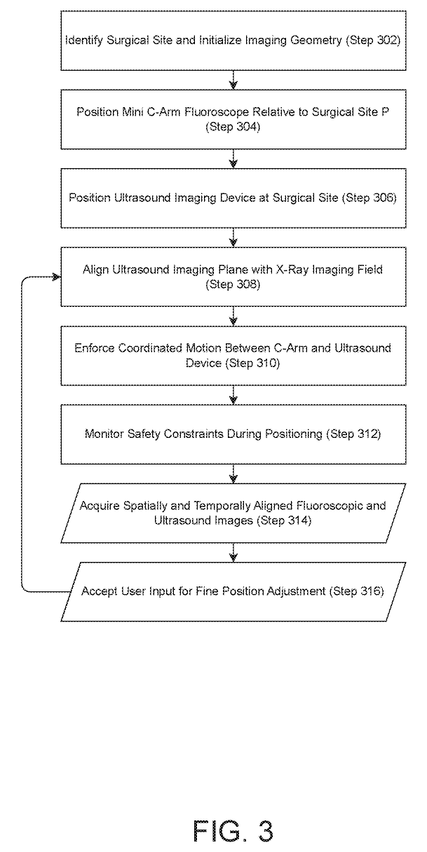

FIG. 3 is a flowchart illustrating an example method performed by system 100 for coordinated positioning and operation of multimodal imaging devices relative to a surgical site P. The flowchart represents a sequence of control steps executed by the control unit and imaging coordination module to align fluoroscopic and ultrasound imaging modalities to a common anatomical region.

In step 302, the system identifies a target surgical site P and determines an initial imaging geometry based on patient position, surgical context, and preoperative or intraoperative inputs. The articulated robotic arm 104 is initialized with kinematic constraints and calibration data defining the spatial relationship between the imaging devices.

In step 304, the articulated arm 104 positions the mini C-arm fluoroscopic imaging device 112 such that the region of interest lies between the X-ray source 112a and the X-ray detector 112b, thereby establishing an X-ray imaging field 113 that encompasses the surgical target anatomy.

In step 306, the articulated arm 104 positions the ultrasound imaging device 114 so that an ultrasound transducer is placed in contact with the patient’s skin at or near the periphery of the surgical site P, or on an exposed organ, to acquire ultrasound image data corresponding to the same region of interest.

In step 308, the imaging coordination module 212 aligns the fluoroscopic and ultrasound modalities by orienting the ultrasound imaging plane 115 to intersect the X-ray imaging plane at the target anatomy. This alignment is performed using known kinematics of the articulated arm 104, device calibration parameters, and spatial registration data to ensure overlap of the respective fields of view.

In step 310, the system optionally enforces coordinated motion constraints between the fluoroscopic imaging device 112 and the ultrasound imaging device 114, such that movement or rotation of the C-arm about the patient causes a corresponding automatic repositioning of the ultrasound probe to maintain imaging alignment with the target anatomy.

In step 312, the control unit monitors safety constraints during positioning, including maintaining clearance between the C-arm 112 and the patient except along the intended imaging path, limiting contact force applied by the ultrasound probe 114, and ensuring that robotic motion does not breach sterile field boundaries or collide with personnel.

In step 314, the system acquires temporally and spatially corresponding fluoroscopic and ultrasound image data while maintaining the aligned geometry, thereby enabling multimodal imaging of the same anatomical cross-section or region.

In step 316, the system optionally accepts surgeon input via a user interface, voice command, or gesture command to fine-tune the relative positioning of one or both imaging devices, after which the method may return to step 308 to update alignment.

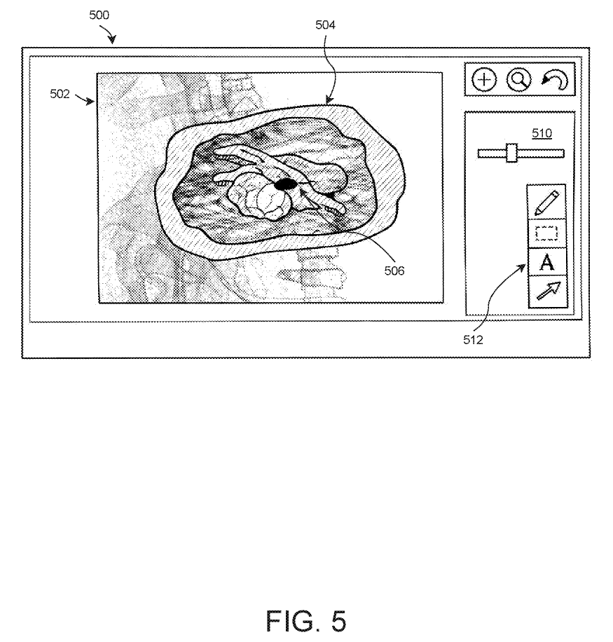

By executing the steps illustrated in FIG. 3, the system produces spatially registered multimodal image data suitable for subsequent image fusion and overlay, as described with reference to FIG. 5, enabling complementary visualization of dense anatomical structures using fluoroscopy and soft tissue structures using ultrasound.

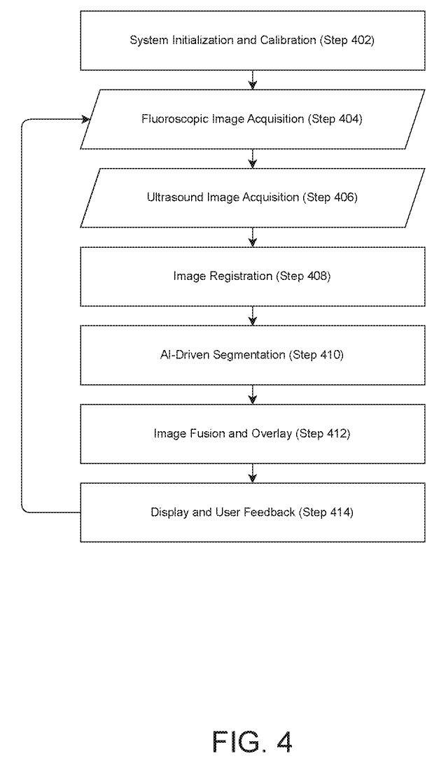

Now turning to FIG. 4, a flowchart is shown depicting the multimodal imaging, registration, and fusion process carried out by system 100, with integration of AI-driven segmentation. The process 400 illustrates how data from the two primary imaging modalities (fluoroscopy and ultrasound) is collected and combined to produce a fused image for the surgeon. The steps in this process are described sequentially below:

System Initialization and Calibration (Step 402): The process begins with the system initializing its components and calibrating the imaging devices. This may involve booting up the control unit 210, establishing communication with the fluoroscope 112 and ultrasound 114, and loading any pre-operative data. Calibration procedures ensure that the spatial relationship between the fluoroscopic C-arm and the ultrasound probe is known (for instance, the system may use a phantom or fiducial markers at the start to align coordinate systems of the two modalities). The arm 104 might also perform a self-check and move to a ready position.

Fluoroscopic Image Acquisition (Step 404): Next, the system acquires an X-ray image of the surgical site using the mini C-arm 112. The arm 104 positions the C-arm appropriately (as illustrated in FIG. 3) and the X-ray source 112a emits a controlled X-ray pulse. The detector 112b captures the resulting fluoroscopic image of the patient’s internal structures. This image could be a single frame or a short sequence if continuous imaging is needed. The raw fluoroscopic image data is sent to the image fusion engine 220 for processing.

Ultrasound Image Acquisition (Step 406): Almost concurrently (or immediately after the X-ray), the system acquires an ultrasound image using ultrasound device 114. The articulated arm 104 ensures the ultrasound transducer is in the correct position and orientation (as per FIG. 3). The ultrasound device then captures a real-time image (or a series of frames) of the target

area. Ultrasound imaging might involve adjusting frequency or depth settings to focus on the region of interest. The captured ultrasound image data is also fed into the fusion engine 220. Steps 404 and 406 can be performed in rapid succession or even simultaneously, depending on system capability and surgical requirements, so that the two images correspond in time.

Image Registration (Step 408): Once both images are obtained, the fusion process continues with registering the fluoroscopic and ultrasound images to each other. In this step, the system aligns the two images in a common frame of reference. Registration can utilize the known spatial configuration from calibration (the relative positions of 112 and 114 from the arm’s sensors) and may also use software algorithms to fine-tune alignment. For example, if a certain anatomical landmark (like a distinct bone edge or a fiducial marker placed on the patient) is visible in both images, the software can adjust scaling, rotation, or translation so that those landmarks coincide. The output of this step is a transformation matrix or mapping that correlates each pixel/voxel of the ultrasound image with the fluoroscopic image coordinate system.

AI-Driven Segmentation (Step 410): After registration, the system applies an AI-driven image analysis to the captured data. In this step, one or more algorithms (such as a trained neural network or other machine vision techniques) process the fluoroscopic and ultrasound images to identify and segment key anatomical structures or surgical targets. For instance, the segmentation module 612 (FIG. 6) might outline the edges of bones, detect surgical instruments in the X-ray image, and delineate soft tissue structures (like tumors, blood vessels, or organs) in the ultrasound image. This can include applying enhancement filters to improve image quality (e.g., noise reduction on the ultrasound, contrast enhancement on X-ray) and then labeling areas of interest. The AI may highlight regions such as a needle path, a target lesion, or critical structures to avoid. The result of this step is metadata indicating the locations of these structures in each image (for example, a mask or set of contours for each identified object).

Image Fusion and Overlay (Step 412): Once the images are registered and the key features are identified, the fusion engine creates a composite fused image. In step 412, the system overlays or combines the ultrasound image data with the fluoroscopic image. There are multiple ways this can be done: one common approach is overlaying the ultrasound information as a translucent layer on the X-ray image. For example, the ultrasound’s depiction of soft tissue could be superimposed in false color on the X-ray, or important outlines from the ultrasound (like the boundary of a tumor) could be drawn as a contour on the X-ray image. The segmented

structures from step 410 can be highlighted – for instance, the system might draw a colored outline 506 (FIG. 5) around a blood vessel from the ultrasound onto the X-ray view so the surgeon sees the vessel’s location relative to bones visible under X-ray. The fusion module 614 ensures that the overlay is done with the proper alignment from step 408, so the images correctly correspond. The end product is a fused multimodal image that integrates the strengths of both modalities into one view.

Display and User Feedback (Step 414): In the final step, the system displays the fused image on the interactive display 230 for the surgical team. The composite image (and/or the individual component images if desired) is presented, typically in real-time or near real-time, so the surgeon can use it for guidance. The display might update continuously if the system is capturing a live sequence (for example, continuous ultrasound with periodic X-ray shots). Additionally, the system’s interface allows the surgeon to provide feedback or adjust what is displayed – e.g., they might increase the transparency of the ultrasound overlay or switch to a side-by-side view of X-ray and ultrasound if needed. This step also includes the system logging the images and possibly sending the fused results to storage 240. If the procedure is ongoing, the process can loop back (arrow from step 414 back to 404) to acquire the next set of images, thus providing updated fused images throughout the surgery as needed.

With the imaging and fusion process described, FIG. 5 provides a schematic representation of the fused composite image and the features of the display interface that presents it. In this illustrative diagram, a composite image 500 is shown on a screen. The base image 502 is the fluoroscopic X-ray view of the surgical site (for example, showing bone structure or a medical device inside the patient). Overlaid on this, an ultrasound (or camera) image region 504 is visible, aligned to the correct anatomical location. In practice, the ultrasound portion 504 might cover only a portion of the screen where the ultrasound was directed, and it could be rendered with a different color hue or transparency to distinguish it from the X-ray background. FIG. 5 shows example visual indicators 506, such as colored outlines or shading, which result from the AI segmentation in step 410. For instance, element 506 could highlight a blood vessel or soft tissue boundary identified in the ultrasound and now superimposed on the X-ray image. Likewise, an outline of a surgical instrument detected in the X-ray could be enhanced or labeled. The display interface also includes various interactive controls 510 schematically shown around or as part of the image. These interface elements allow the user to manipulate the composite view without touching non-sterile equipment (if using touch, the screen would be placed in a sterile cover or the user might use a sterile stylus). Example controls and features include: a modality toggle switch to turn on/off the ultrasound overlay or switch between viewing modes (e.g., only X-ray, only ultrasound, or fused view), a slider to adjust the transparency or intensity of the overlay, zoom and pan controls to magnify the image 500 or focus on a particular region, and annotation tools 512 enabling the user to draw or place markers on the image. The system can also display auxiliary information on the interface, such as the current X-ray dose rate, the frame rate of ultrasound, or a mini-map showing probe orientation. In some embodiments, the interface 230 is voice and gesture responsive (as per module 250): for instance, the surgeon could say "show X-ray only" to hide the ultrasound layer, or use a hand gesture to zoom in on the image (these interactions are detailed in FIG. 8). FIG. 5 thus illustrates how the fused imaging data is presented in a user-friendly way, combining both modalities into a single coherent visualization. The surgeon is able to see the real-time composite image 500 during the operation, which can greatly assist in navigation (for example, seeing a needle advancing on X-ray while also seeing soft tissue detail from ultrasound). The interface’s ability to allow procedural annotation means the surgeon can mark points of interest (such as a target location for a biopsy) on the image, and those annotations can be saved along with the image data for later reference.

FIG. 6 is a block diagram delving into the components of the image fusion engine 220, showing its inputs, processing stages, and outputs. The fusion engine 220 is typically implemented in software executing on the system’s computing hardware (which may be located on base 102 or in a connected control unit), optionally augmented by specialized processors (GPUs or FPGAs) for image processing tasks. As illustrated in FIG. 6, the engine 220 receives multiple inputs: a fluoroscopic image input 602 from the X-ray device 112, an ultrasound image input 604 from the ultrasound device 114, and potentially additional inputs 606 from other modalities or sources such as a camera. Additional inputs 606 can include, for instance, an optical camera feed, a preoperative MRI/CT image for reference, or depth sensor data, though the primary focus remains on X-ray and ultrasound in this embodiment. The first processing stage within engine 220 is a registration module 610. Module 610 takes the incoming images (602, 604) and performs the alignment computations as described for step 408. It uses calibration data 611 (which may be stored from the init step 402) to map the coordinate system of the ultrasound to that of the X-ray. The registration module 610 may output an aligned ultrasound image or transformation parameters that are passed along.

Next, the data flows into a segmentation and analysis module 612. This corresponds to the AI-driven segmentation step 410: the module 612 runs one or more algorithms to analyze the content of the images. It may run separate specialized routines on the fluoroscopic image and on the ultrasound image, or a unified model that looks at both. For example, module 612 can contain a neural network trained to recognize anatomical patterns in ultrasound images (e.g., differentiating tissue types) and another trained to identify structures in X-rays (like edges of bones or catheters). It produces outputs such as masks 613 or labeled coordinates of recognized features in each image. These outputs essentially annotate the images with information like "region A is bone, region B is a blood vessel." In some implementations, module 612 could fuse some information at this stage already, for instance, if it recognizes the same structure appearing in both images, it could link those. The segmentation module may also apply real-time enhancement filters on the raw images (e.g., filtering out noise in ultrasound, adjusting contrast in X-ray) to improve the quality for both human viewing and algorithm performance. Additionally, module 612 can generate anatomical labels or tags that will eventually be displayed (like text or symbols indicating anatomical landmarks).

The next stage shown is the fusion module 614, which takes the processed outputs (aligned images and segmentation data) and constructs the composite visualization. Fusion module 614 overlays the images and inserts any highlighting graphics as needed. For example, it will use the alignment info from module 610 to overlay pixel data from the ultrasound onto the X-ray image in the correct position. It also applies the segmentation info from module 612 to draw outlines or color-code different structures. The fusion module 614 essentially generates a new image (or image set) that is a combination of the two inputs. In some embodiments, it might also generate a three-dimensional reconstruction (for example, if multiple angles of X-ray are taken or the ultrasound is swept in 3D, the system could create a 3D model combining both modalities). Such 3D reconstructions are an optional output and may be displayed as volume renderings or cross-sectional slices, depending on the system’s capabilities. Once the fusion step is done, the composite image data 615 is ready for output.

On the output side, FIG. 6 shows two primary destinations: a display output module 616 and a data storage output 622. The display output 616 formats the fused image (and any graphical user interface elements like those 510/512 from FIG. 5) for the interactive display 230. It ensures that the resolution, color format, and any interactive overlay (like cursors or menus) are correctly rendered on the screen or AR headset. This output is what the surgeons actually see in real-time. The data storage output 622 represents the archiving of information: the fusion engine 220 can save the original images, the fused images, and the associated metadata (like segmentation results, time stamps, and annotation text) to the data storage system 240. This archival can be important for postoperative analysis, medicolegal record-keeping, or training purposes. The stored data might include, for example, a series of fused image frames with tags indicating which step of surgery they correspond to, or a 3D model of the anatomy that was constructed during the operation. In some cases, the fusion engine can also send outputs to other systems (not explicitly shown in FIG. 6) such as an augmented reality (AR) subsystem if surgeons are wearing AR glasses – in that scenario, the output might be a stream of graphics to overlay on the surgeon’s view of the patient. FIG. 6 emphasizes how multiple inputs are processed through distinct stages (610, 612, 614) in the image fusion engine 220 to yield a unified imaging output that is both displayed in real-time and stored for integration with health records or further analysis.

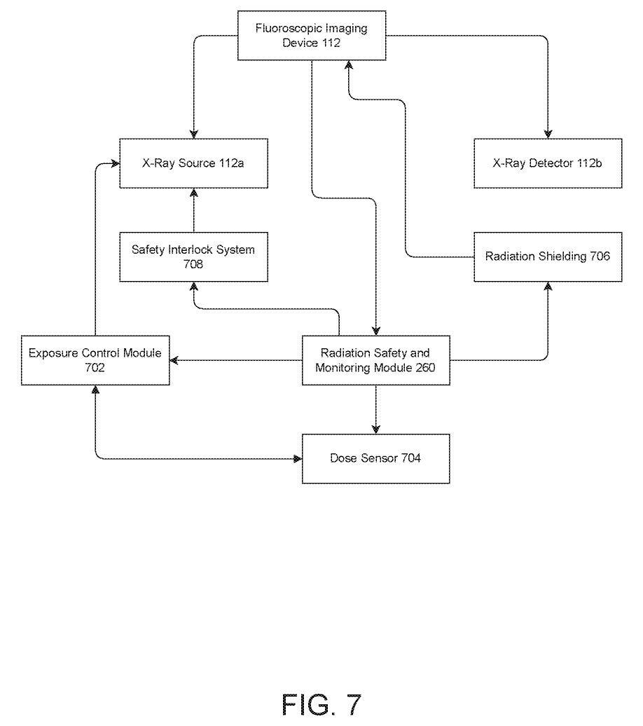

Next, FIG. 7 illustrates the radiation safety components of the system 100, focusing on how X-ray dose is controlled and how shielding is implemented. Because the system employs fluoroscopic imaging, it is critical to ensure patient and staff safety from X-ray radiation. In FIG. 7, the fluoroscopic C-arm 112 is depicted alongside a schematic of safety mechanisms. The X-ray source 112a is under the governance of an exposure control module 702 (part of the radiation safety module 260 in FIG. 2). The exposure control 702 monitors the real-time output of the X-ray source and adjusts parameters automatically to minimize dose. For example, if the imaging area is a small anatomical region or if the detector 112b is receiving a strong signal (indicating the image is bright enough), module 702 can reduce the X-ray tube current or shorten the pulse duration. The system can also tailor the X-ray settings based on patient characteristics: it may use the patient’s size or the density of the target tissue (possibly inferred from the initial images or preset by the user) to select the lowest acceptable exposure that still produces a clear image. This automatic exposure adjustment helps prevent unnecessary radiation – for instance, the system might use a lower dose for a thin body part and only ramp up if a denser part is imaged.

FIG. 7 also shows a dose sensor 704, which could be a physical sensor near the detector or integrated into the detector 112b, that measures the actual dose received per image and accumulates the total exposure over time. The readings from sensor 704 feed back into module 702 to ensure the dose stays within safe limits. If the cumulative dose is approaching a threshold (for example, a limit set for that procedure or patient), the system could alert the surgical team or automatically switch the imaging to a different modality to avoid further X-ray use. In addition to controlling the X-ray source, the system incorporates physical shielding 706 to protect the surgical staff (and parts of the patient’s body that are not of interest) from radiation. In FIG. 7, shielding 706 is depicted schematically as panels or barriers attached to the C-arm or base. These could be lead-equivalent acrylic shields mounted on the arm that block scatter radiation emanating from the patient. For example, a transparent shield could be positioned between the X-ray source and where a surgeon or nurse might stand, absorbing stray radiation. The shielding 706 could also include a drape or curtain that covers the patient except the area being imaged, thereby limiting exposure to other regions.

Another critical component shown in FIG. 7 is the safety interlock system 708. The interlocks are designed to ensure that X-rays are only produced under safe conditions. They may include sensors that detect the position of the C-arm 112 relative to the patient and environment – for instance, a proximity sensor that verifies the C-arm is properly closed around the body part (so that the X-ray beam will hit the detector and not open air). If the C-arm is not correctly positioned or if the detector 112b is removed, the interlock will prevent the X-ray from firing. Interlocks can also tie into the presence of personnel: for example, a motion sensor or vision system could detect if a non-protected person inadvertently steps between the X-ray source and detector, and immediately pause imaging to avoid direct exposure to that person. Furthermore, the system may require confirmation that all users are at a safe distance or wearing appropriate lead aprons before enabling fluoroscopy – this could be done via a checklist in software or even badge sensors. Module 708 communicates with the main control unit 210 to halt X-ray generation if any condition is violated (like a panel 706 being out of place, or the arm 104 drifting from the set position). The radiation safety and compliance mechanisms also log every X-ray shot’s parameters (dose, duration, angle, etc.) as part of the patient’s record for compliance with health regulations. In summary, FIG. 7 highlights that the system 100 actively manages radiation safety through automatic dose control (702 and 704), physical shielding barriers (706), and interlock safeguards (708) to prevent overexposure. These features work together to make the fluoroscopic aspect of the cobot as safe as possible for both patients and operating room staff.

Finally, FIG. 8 depicts the voice and gesture command interaction system that allows sterile, hands-free control of the cobotic imaging system 100. In the illustrated scenario of FIG. 8, a surgeon 800 is in the operating room with the system, and issues commands without touching any interface – maintaining the sterile field. A microphone 802 on the system (for example, mounted on the display 230 or on the base 102) picks up the surgeon’s verbal command, which could be a predefined phrase such as "move arm left" or "switch to ultrasound mode." The audio input is processed by a speech recognition module 804, which is part of the voice command interface (corresponding to module 250 in FIG. 2). The speech recognition module 804 uses language processing algorithms (potentially with a vocabulary limited to system commands) to interpret the instruction. For instance, upon recognizing the phrase "move arm left 5 centimeters," the system will translate that into a movement command for the robotic arm 104 to reposition the imaging assembly accordingly. The voice interface can also handle commands like "capture image now" to trigger an imaging sequence, or "zoom in" to affect the display. To ensure safety and accuracy, the system may employ speaker identification or a push-to-talk mechanism (maybe via a foot pedal) so that only authorized personnel’s commands are executed and accidental ambient speech is ignored. The voice command interface greatly enhances usability by letting the surgeon control imaging without needing to have a hand free or break sterility to touch a console.

In addition to voice, FIG. 8 illustrates a gesture control aspect of interface 250. A depth camera or infrared sensor 806 (or another visual sensor) is aimed at the user area to detect hand motions or body gestures made by the surgeon 800 (or other authorized staff). The figure indicates a gesture like a hand wave or a specific hand sign (for example, the surgeon pointing toward the left) being performed. The input from sensor 806 is sent to a gesture recognition module 808, which interprets the motion in the context of known command gestures. For example, the system might be trained that a clockwise circular hand motion means "rotate the C-arm clockwise," or a swipe motion means "move to the next image." Another possible gesture is the surgeon literally pointing on the displayed image (if using a system with a depth sensor that can see where on the screen the surgeon’s finger is hovering) – the system could interpret that as selecting a point of interest, akin to a touch. The recognized gesture is then converted to a command for the control system. Arrow 810 in FIG. 8 represents the flow of voice command data (from microphone 802 to speech module 804 to control unit 210), and arrow 812 represents the flow of gesture data (from camera 806 to gesture module 808 to control unit 210). Through these pathways, the surgeon’s intent – whether spoken or gestured – is understood by the cobot.

Once the command is interpreted, the control unit 210 (or directly the respective subsystem) carries out the action. For instance, if the surgeon makes a spreading gesture to zoom, the display interface 230 will enlarge the image accordingly; if the surgeon says "ultrasound on," the coordination module 212 might activate the ultrasound device 114 and perhaps overlay its image on the display. The system is designed to filter out false positives and to only act on deliberate commands. It maintains sterile workflow integrity by eliminating the need for the surgeon to touch any non-sterile surfaces – all interaction can be done verbally or with in-air hand motions. FIG. 8 demonstrates this interactive capability: the surgeon 800 can, in the middle of a procedure, adjust the imaging parameters or request a different view without stepping away from the patient or contaminating their gloves. This interface (250) is typically active only for authorized users; for example, a voice recognition feature might recognize the surgeon’s voice or require an activation phrase to prevent anyone else’s speech from moving the robot inadvertently. The combination of voice and gesture control provides a robust human-machine interaction layer for the cobotic imaging system, making it more intuitive and seamlessly integrated into surgical workflows.

In conclusion, the detailed description above has presented a perioperative cobotic system with multimodal imaging capabilities. We described the physical configuration of the system including the mobile base, articulated arm, and integrated fluoroscopic, optical and ultrasound imaging devices (FIG. 1), the system architecture and components (FIG. 2), the coordinated operation of dual modalities (FIG. 3), the process of image acquisition, fusion, and AI-driven enhancement (FIG. 4), the visualization of fused images and user controls (FIG. 5), the internal workings of the image fusion engine (FIG. 6), the radiation safety features ensuring safe fluoroscopic use (FIG. 7), and the advanced voice/gesture interface for user interaction (FIG. 8). This comprehensive system enables surgeons to obtain and visualize real-time fused fluoroscopic and ultrasonic images during surgery, improving situational awareness while maintaining safety and sterility in the operating room. The terminology and approach herein are consistent with the cobotic systems described in related applications, and it will be understood that various changes in form and detail can be made without departing from the scope of the invention as defined by the claims.

While specific embodiments have been described to enable practice of the disclosed subject matter, they are illustrative and not limiting. Variations, modifications, substitutions, and combinations of the features described can be made by those skilled in the art without departing from the scope of this disclosure. Features described with respect to one embodiment may be used with, or substituted for, features of another. Unless expressly stated otherwise, the terms “comprising,” “including,” and “having” are used in an open, non‑limiting sense; the singular forms “a,” “an,” and “the” include the plural forms; and stated ranges include their endpoints and all subranges. Unless the context clearly indicates otherwise, “and/or” means one or more of the listed items (e.g., “A and/or B” encompasses A alone, B alone, or both A and B); “or” is inclusive (i.e., “A or B” means A, B, or both); and “and” is conjunctive. Headings and ordering are for convenience and do not limit the description. The scope of the claimed subject matter is defined solely by the claims that follow and their legal equivalents.

What is claimed is:

1. A perioperative cobotic imaging system, comprising:
an imaging assembly comprising at least a fluoroscopic imaging device and an ultrasound imaging device, the imaging assembly being configured to capture real-time intraoperative image data of a surgical site;
a mobile collaborative robotic platform including a mobile base and an articulated arm supporting the imaging assembly, the robotic platform being configured for autonomous or semi-autonomous navigation within an operating room and for positioning the imaging assembly relative to a patient; and
a control unit operatively coupled to the imaging assembly and the robotic platform, the control unit comprising one or more processors and being configured to:
synchronize acquisition of the fluoroscopic and ultrasound image data and calibrate the spatial relationship between the imaging devices to a common coordinate frame;
automatically fuse the real-time image data from the fluoroscopic imaging device and the ultrasound imaging device to generate a composite image of the surgical site, while applying an artificial intelligence algorithm to segment and highlight anatomical structures in the composite image; and
provide the composite image and associated segmented overlays to an interactive display in real time for viewing and control by surgical personnel, and coordinate adjustments of the articulated arm in response to user inputs or changes in the surgical environment.

2. The system of claim 1, further comprising at least one high-resolution optical camera configured to capture visible-spectrum images or video of the surgical field, wherein the control unit is configured to incorporate the optical images into the multimodal image data for documentation or supplemental visualization.

3. The system of claim 1, wherein the control unit’s artificial intelligence algorithm comprises a machine learning-based image recognition model trained on surgical imaging data to identify a plurality of anatomical structures and surgical instruments, and to generate labeled overlays on the composite image indicating the identified structures in real time.

4. The system of claim 1, further comprising an interactive display interface in communication with the control unit, the display interface being configured to present the fused composite image to the surgical team in real time and to provide user-selectable controls to toggle between different imaging modalities, adjust image viewing parameters, or add procedural annotations during surgery.

5. The system of claim 1, further comprising a data storage and integration module configured to archive the captured fluoroscopic image data, ultrasound image data, and composite images with associated patient and procedure identifiers, and to automatically synchronize and upload the archived imaging data to at least one of an electronic medical record system or a picture archiving and communication system for post-operative review and record-keeping.

6. The system of claim 1, further comprising a voice and gesture command interface coupled to the control unit, wherein the control unit is configured to respond to hands-free voice commands or sterile gestural inputs from authorized surgical personnel to adjust one or more imaging parameters or to reposition the imaging assembly via the articulated arm without physical contact, thereby maintaining a sterile field workflow.

7. The system of claim 1, wherein the fluoroscopic imaging device includes integrated radiation shielding to protect nearby personnel and a dose monitoring sensor to track radiation exposure, and wherein the control unit is configured to automatically adjust X-ray emission parameters in real time based on patient size, target anatomy, and imaging depth, and to interrupt or prevent fluoroscopic exposure when a predefined radiation dose threshold or an improper alignment condition is detected, thereby enhancing radiation safety compliance.

8. The system of claim 1, wherein the mobile collaborative robotic platform comprises a docking mechanism configured to stabilize the imaging assembly during image acquisition by releasably coupling the mobile base to a fixed structure in the operating room, thereby reducing motion of the imaging assembly and ensuring image clarity during fluoroscopic or ultrasound scans.

9. The system of claim 1, wherein the control unit and robotic platform are configured to avoid breaching sterile field boundaries or colliding with personnel, by utilizing proximity sensors and predefined safe-zone constraints that cause the robotic platform or articulated arm to automatically slow, stop, or reroute its movement upon detecting an encroachment of a sterile field or the presence of a person in its path.

10. The system of claim 1, wherein the control unit is further configured to retrieve preoperative or reference medical images of the patient from an external data source and to display the retrieved images in conjunction with the real-time composite image on the interactive display, thereby assisting surgical navigation and verification by allowing comparison between intraoperative fused images and prior diagnostic images or surgical plans.

11. An image fusion engine for a perioperative cobotic imaging system, the image fusion engine comprising:
an input interface configured to receive real-time image data in parallel from a fluoroscopic imaging device and an ultrasound imaging device during a surgical procedure;
a registration module configured to mathematically align the fluoroscopic image data and the ultrasound image data to a common coordinate system using calibration data for the imaging devices;
an image processing module configured to fuse the aligned fluoroscopic and ultrasound image data to generate a real-time composite image that combines features of both modalities;
an analysis module including at least one machine learning algorithm configured to automatically segment the composite image to identify anatomical structures or surgical tools and to produce segmented overlays or annotations corresponding to those identified features; and
an output interface configured to stream the composite image with the segmented overlays for real-time display or integration into a surgical guidance system.

12. The image fusion engine of claim 11, wherein the machine learning algorithm of the analysis module is a trained artificial intelligence model that has been trained on multimodal medical images to recognize specific anatomical features and pathologies, and wherein the analysis module generates color-coded or highlighted overlays in the composite image to label organs, blood vessels, bones, or surgical instruments identified within the operative field.

13. The image fusion engine of claim 11, wherein the image processing module further comprises an image enhancement sub-module configured to apply real-time filtering or amplification to at least one of the incoming ultrasound image data or fluoroscopic image data prior to or during fusion, thereby improving the clarity and utility of the composite image for the surgeon.

14. The image fusion engine of claim 11, wherein the image fusion engine is configured to generate a three-dimensional reconstruction of the surgical site by combining multiple two-dimensional images from the fluoroscopic imaging device taken at different angles with real-time ultrasound data, the engine thereby producing a three-dimensional composite visualization or model that can be rotated or sliced for enhanced intraoperative guidance.

15. The image fusion engine of claim 11, wherein the registration module utilizes one or more fiducial markers, sensor tracking data, or known geometric relationships to calibrate and maintain accurate spatial alignment between the fluoroscopic and ultrasound images, such that the composite image overlays corresponding anatomical structures from both modalities with sub-millimeter accuracy.

16. The image fusion engine of claim 11, wherein the output interface is configured to transmit the fused composite image and segmented overlays to an augmented reality (AR) or heads-up display system, such that a surgeon wearing an AR headset can view the composite image superimposed in real time onto the surgeon’s view of the patient, with the segmented anatomical structures highlighted in alignment with the patient’s actual anatomy.

17. A robotic articulation and positioning apparatus for a perioperative imaging system, comprising: a mobile base configured for movement within an operating room and for stable positioning adjacent to a surgical table; an articulated robotic arm mounted on the mobile base and configured to support and maneuver an imaging device around a patient; and a control system comprising one or more processors in communication with the robotic arm, the control system being programmed to autonomously or semi-autonomously actuate the robotic arm to position the imaging device at a desired orientation and distance relative to the patient’s anatomy in real time, wherein the apparatus is configured for collaborative operation in a surgical environment such that it can safely operate in proximity to surgical personnel during a procedure.

18. The apparatus of claim 17, wherein the articulated robotic arm provides at least six degrees of freedom of movement, including multiple rotational joints and linear actuators, thereby allowing the imaging device to be positioned at a wide range of angles and orientations around the patient and to reach different anatomical sites without needing to reposition the patient.

19. The apparatus of claim 17, wherein the control system is configured to perform dynamic compensation for patient movement or operating table adjustments by automatically adjusting the position and orientation of the imaging device via the robotic arm in response to sensed changes, thereby maintaining an optimal imaging alignment and consistent field of view on the target anatomy throughout the surgical procedure.

20. The apparatus of claim 17, further comprising one or more safety sensors selected from the group consisting of proximity sensors, force/torque sensors, and vision-based detectors, wherein the control system utilizes signals from the safety sensors to detect potential collisions or unsafe interactions and is configured to automatically slow down or stop the movement of the robotic arm and to impose force limits if an unexpected resistance or human presence is detected, thereby maintaining safe collaboration with surgical staff and preventing inadvertent contact or injury during operation.
